(19) United States
(12) Patent Application Publication
(10) Pub. No.: US 2025/0029383 A1
(43) Pub. Date: Jan. 23, 2025

(54) RELATIONSHIP EXTRACTING APPARATUS, RELATIONSHIP EXTRACTING METHOD, AND STORAGE MEDIUM

(71) Applicants: NEC CORPORATION, Tokyo (JP); National University of Singapore, Singapore (SG)

(72) Inventors: Karen STEPHEN, Tokyo (JP); Satoshi Yamazaki, Tokyo (JP); Jianquan LIU, Tokyo (JP); Rishabh Sheoran, Singapore (SG); Yong Kang Wong, Singapore (SG); Mohan Kankanhalli, Singapore (SG)

(73) Assignees: NEC CORPORATION, Tokyo (JP); National University of Singapore, Singapore (SG)

(21) Appl. No.: 18/777,827

(22) Filed: Jul. 19, 2024

(30) Foreign Application Priority Data
Jul. 20, 2023 (SG) 10202302053T

(51) Int. Cl. G06V 20/40

(52) U.S. Cl. CPC G06V 20/44; G06V 20/41; G06V 20/46

(57) ABSTRACT

A relationship extracting apparatus acquires event information that indicates features of an event of interest, determine target duration based on one or more features of the event of interest, and extract one or more action-related relationships that exist during the target duration from object relationships information. The object relationship information indicates two or more action-related relationships between objects in association with time at which or during which the action-related relationship exists.

### INCORPORATION BY REFERENCE

This application is based upon and claims the benefit of priority from Singaporean patent application Ser. No. 10202302053T, filed on Jul. 20, 2023, the disclosure of which is incorporated herein in its entirety by reference.

### TECHNICAL FIELD

The present disclosure generally relates to relationship extracting apparatus, relationship extracting method, and storage medium.

### BACKGROUND ART

There are techniques to provide information of an event of interest. International Patent Publication No. WO 2001/033863 discloses a technique to detect a significant scene that is a part of an event from source video, and extract a key frame for the scene.

### SUMMARY

The key frame provided by International Patent Publication No. WO 2001/033863 represents a part of the event. Thus, International Patent Publication No. WO 2001/033863 does not provide information that is not included in the event. An example objective of this disclosure is to provide a novel technique to provide information relevant to an event of interest.

In a first example aspect, a relationship extracting apparatus comprising: at least one memory that is configured to store instructions; and at least one processor. The at least one processor is configured to execute the instructions to: acquire event information that indicates one or more features of an event of interest; determine target duration based on the one or more features of the event of interest, the target duration including, as a part thereof, an event time at which or during which the event of interest occurs; and extract one or more action-related relationships that exist during the target duration from object relationships information, which indicates two or more action-related relationships between objects in association with time at which or during which the action-related relationship exists.

In a second example aspect, an relationship extracting method comprising: acquiring event information that indicates one or more features of an event of interest; determining target duration based on the one or more features of the event of interest, the target duration including, as a part thereof, an event time at which or during which the event of interest occurs; and extracting one or more action-related relationships that exist during the target duration from object relationships information, which indicates two or more action-related relationships between objects in association with time at which or during which the action-related relationship exists.

In a third example aspect, a non-transitory computer-readable storage medium storing a program that causes a computer to execute: acquiring event information that indicates one or more features of an event of interest; determining target duration based on the one or more features of the event of interest, the target duration including, as a part thereof, an event time at which or during which the event of interest occurs; and extracting one or more action-related relationships that exist during the target duration from object relationships information, which indicates two or more action-related relationships between objects in association with time at which or during which the action-related relationship exists.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 illustrates an overview of a relationship extracting apparatus;

FIG. 2 is a block diagram illustrating an example of the functional configuration of the relationship extracting apparatus;

FIG. 3 is a block diagram illustrating an example of the hardware configuration of a computer realizing the relationship extracting apparatus;

FIG. 4 is a flowchart illustrating an example flow of processing performed by the relationship extracting apparatus;

FIG. 5 illustrates an example structure of the object relationship information in a table format;

FIG. 6 illustrates an example structure of the object information in a table format;

FIG. 7 illustrates an example of the scene graph;

FIG. 8 is a flowchart illustrating a flow of processing performed by the object relationship information generating apparatus;

FIG. 9 illustrates an example structure of the duration information in a table format;

FIG. 10 illustrates the target duration that is determined based on the lengths of time predefined in association with the type of event; and

FIG. 11 illustrates an example of the functional configuration of the relationship extracting apparatus 2000 that includes the outputting unit;

### EXAMPLE EMBODIMENT

Hereinafter, example embodiments of the present disclosure are described in detail with reference to the drawings. In the drawings, the same or corresponding element is denoted by the same reference sign, and redundant descriptions are omitted as necessary for clarity of description. Unless otherwise stated, predetermined information (e.g., a predetermined value or a predetermined threshold) is stored in advance in a storage device to which a computer using that information has access unless otherwise described. Further, unless otherwise stated, a storage unit is constituted by one or more storage.

### <Overview>

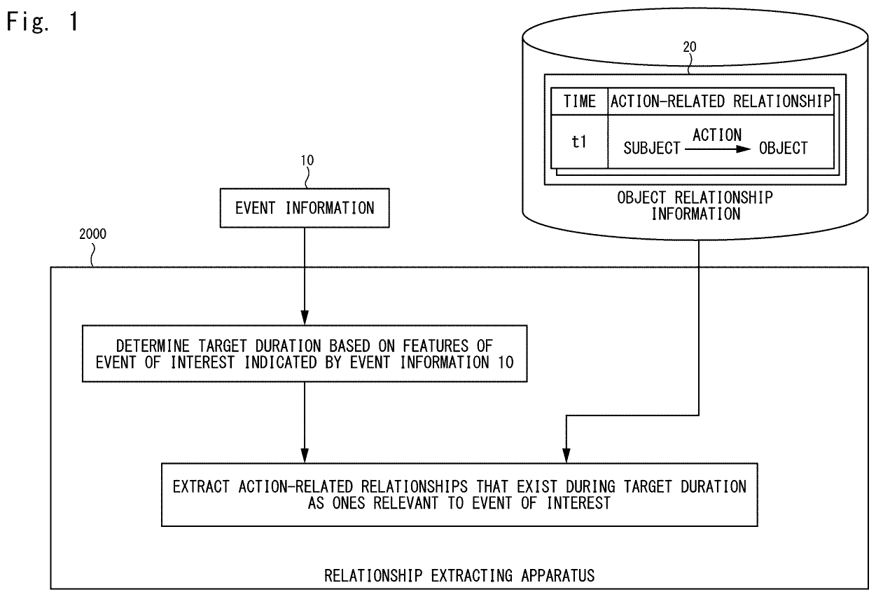

FIG. 1 illustrates an overview of a relationship extracting apparatus 2000. It is noted that the overview illustrated by FIG. 1 shows an example of operations of the relationship extracting apparatus 2000 to make it easy to understand the relationship extracting apparatus 2000, and does not limit or narrow the scope of possible operations of the relationship extracting apparatus 2000.

The relationship extracting apparatus 2000 is used to extract, from object relationship information 20, one or more temporal action-related relationships between objects that are predicted to be relevant to an event of interest. The object relationship information 20 represents a sequence of two or more temporal action-related relationships between objects, each of which is an action-related relationship between objects that is detected from one or more video frames and exists at a certain point in time or during a certain period of time.

The temporal action-related relationship may be represented by a combination of 1) a type of action, 2) a subject of the action, 3) an object of the action, and 4) time when the action is taken. Suppose that there is an action-related relationship in which a person P1 picks up a store item I1 from time T1 to T2. The object relationship information 20 may represent this relationship by a combination of 1) Type of action: Pick up, 2) Subject: Person P1, 3) Object: Store Item I1, and 4) Time: T1 to T2.

The event of interest is an action-related event, which is any type of event that involves one or more actions taken by an object. Types of the action-related event may include criminal events (e.g., Shoplifting and Baggage theft), accidents (e.g., Car accidents and Left baggage), sport events (e.g., Goal event in football game and Home run in baseball game) and customer events (e.g., Purchasing).

The action-related relationship is predicted to be relevant to the event of interest when, at least, the action-related relationship exists during a certain period of time that is relevant to the event of interest. Hereinafter, a period of time that is relevant to the event of interest is called “target duration”.

To extract the action-related relationships relevant to the event of interest, the relationship extracting apparatus 2000 acquires event information 10 to determine the target duration. The event information 10 includes information by which features of the event of interest can be identified.

The features of the event of interest include time when the event of interest occurs. Hereinafter, the time when the event of interest occurs is also called “event time”. The event time may be represented by a specific point in time or a specific period of time. The features of the event of interest also include a type of the event of interest, such as Purchasing, Shoplifting, etc.

The relationship extracting apparatus 2000 determines the target duration based on the event time and the type of the event of interest. The target duration includes the event time as a part thereof. For example, a length of duration May be predefined for each type of the event. In this case, the relationship extracting apparatus 2000 determines the predefined length of duration that corresponds to the type of the event of interest. Then, the relationship extracting apparatus 2000 determines, as a target duration, a period of time that includes the event time and whose length of time is determined based on the predefined length of duration corresponding to the type of the event of interest.

Based on the target duration, the relationship extracting apparatus 2000 searches the object relationship information 20 for the action-related relationships that are relevant to the event of interest to extract them. Specifically, the action-related relationships that exist during the target duration are extracted from the object relationship information 20.

### <Example of Advantageous Effect>

As described above, the relationship extracting apparatus 2000 determines the target duration that includes the event time as a part thereof, based on the features of the event of interest indicated by the event information 10. Then, the relationship extracting apparatus 2000 extracts, from the object relationship information 20, the action-related relationships that exist during the target period as ones relevant to the event of interest.

According to the above-mentioned operation of the relationship extracting apparatus 2000, a novel technique to provide information relevant to an event of interest is provided. Specifically, the action-related relationships that exist during the target duration includes information about what happened before the event of interest, after the event of interest, or both. Thus, the relationship extracting apparatus 2000 facilitates understanding what happened before the event of interest, after the event of interest, or both, thereby facilitating understanding the event of interest in detail.

Furthermore, the relationship extracting apparatus 2000 determines the target duration based on the features of the event of interest, such as the type of the event of interest. This enables the relationship extracting apparatus 2000 to take the features of the event of interest into consideration to determine what information the relationship extracting apparatus 2000 provides.

Hereinafter, more detailed explanation of the relationship extracting apparatus 2000 will be described.

### <Example of Functional Configuration>

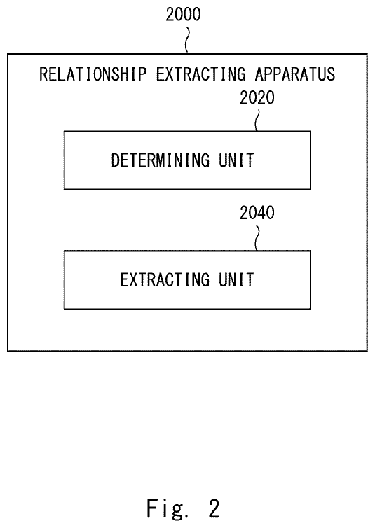

FIG. 2 is a block diagram illustrating an example of the functional configuration of the relationship extracting apparatus 2000. The relationship extracting apparatus 2000 includes a determining unit 2020 and an extracting unit 2040. The determining unit 2020 acquires the event information 10 to determine a target duration based on a type of the event of interest and the event time that are indicated by the event information 10. The extracting unit 2040 extracts the action-related relationships that exist during the target duration as the action-related relationships that are relevant to the event of interest.

### <Example of Hardware Configuration>

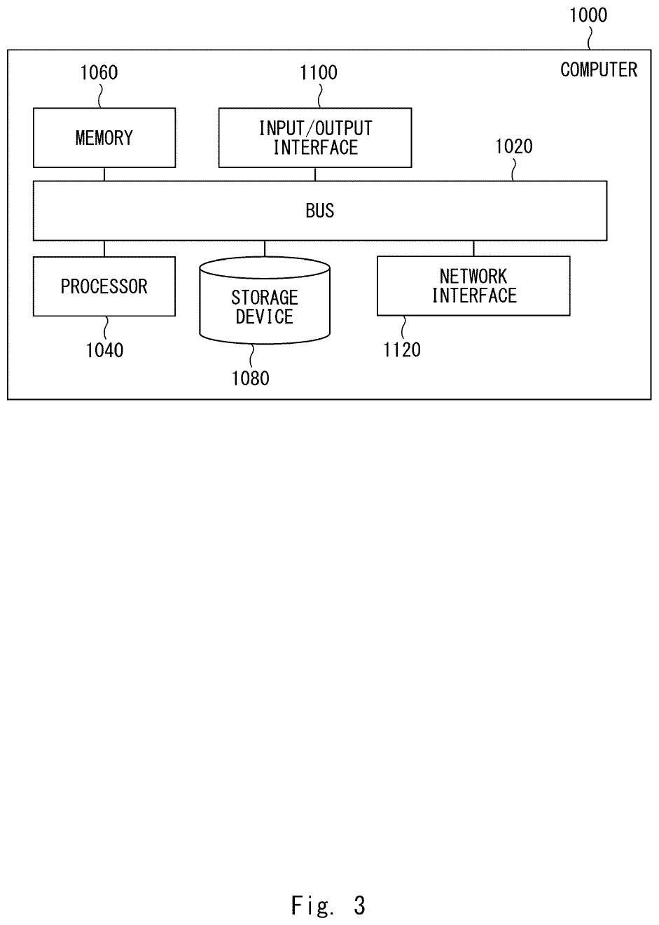

The relationship extracting apparatus 2000 may be realized by one or more computers. FIG. 3 is a block diagram illustrating an example of the hardware configuration of a computer 1000 realizing the relationship extracting apparatus 2000. The computer 1000 may be any type of computer. For example, the computer 1000 is a stationary computer, such as a personal computer (PC) and a server machine. In another example, the computer 1000 is a mobile computer, such as a smartphone and a table terminal. In another example, the computer 1000 is an integrated circuit, such as a SoC (system on chip). The computer 1000 may be a special-purpose computer manufactured for implementing the relationship extracting apparatus 2000 or may be a general-purpose computer.

The relationship extracting apparatus 2000 may be realized by installing an application in the computer 1000. The application is implemented with a program that causes the computer 1000 to function as the relationship extracting apparatus 2000. In other words, the program is an implementation of the functional units of the relationship extracting apparatus 2000.

There are various ways to acquire the program. For example, the program may be acquired from a storage medium (e.g., a DVD disk or a USB memory) in which the program is stored. In another example, the program may be downloaded from a server that manages a storage medium storing the program.

In FIG. 3, the computer 1000 includes a bus 1020, a processor 1040, a memory 1060, a storage device 1080, an input/output (I/O) interface 1100, and a network interface 1120. The bus 1020 is a data transmission channel in order for the processor 1040, the memory 1060, the storage device 1080, and the I/O interface 1100, and the network interface 1120 to mutually transmit and receive data. The processor 1040 is a processer, such as a CPU (Central Processing Unit), GPU (Graphics Processing Unit), DSP (Digital Signal Processor), or FPGA (Field-Programmable Gate Array). The memory 1060 is a primary memory component, such as a RAM (Random Access Memory) or a ROM (Read Only Memory). The storage device 1080 is a secondary memory component, such as a hard disk, an SSD (Solid State Drive), or a memory card. The I/O interface 1100 is an interface between the computer 1000 and peripheral devices, such as a keyboard, mouse, or display device. The network interface 1120 is an interface between the computer 1000 and a network. The network may be a LAN (Local Area Network) or a WAN (Wide Area Network).

The processor 1040 may be configured to load instructions of the above-mentioned program from the storage device 1080 into the memory 1060 and execute those instructions, so as to cause the computer 1000 to operate as the relationship extracting apparatus 2000.

The hardware configuration of the computer 1000 is not restricted to that shown by FIG. 3. For example, as mentioned-above, the relationship extracting apparatus 2000 may be realized as a combination of multiple computers. In this case, those computers may be connected with each other through the network.

### <Flow of Process>

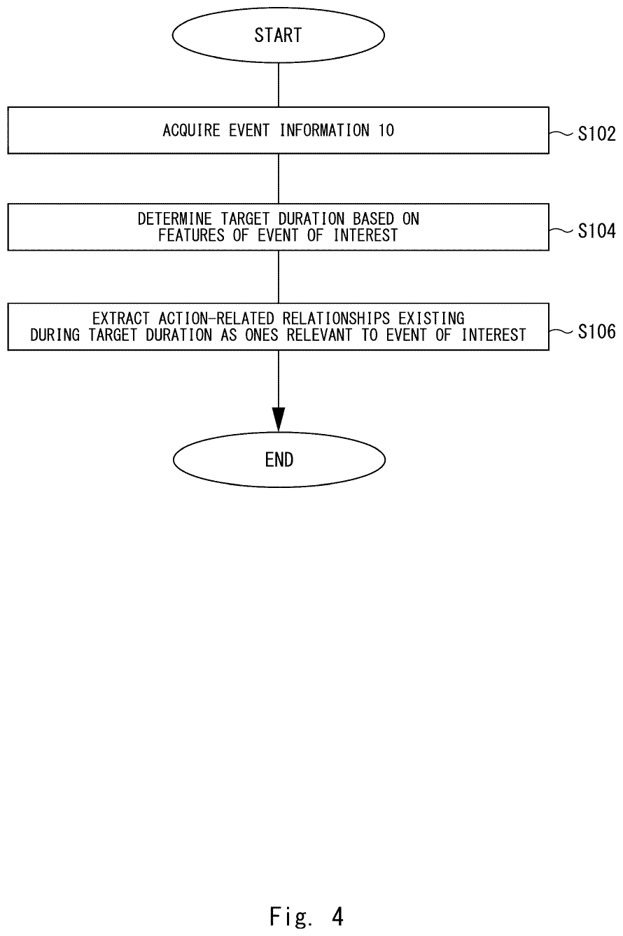

FIG. 4 is a flowchart illustrating an example flow of processing performed by the relationship extracting apparatus 2000. The determining unit 2020 acquires the event information 10 (S102). The determining unit 2020 determines the target duration based on the features of the event of interest (S104). The extracting unit 2040 extracts the action-related relationships that exist during the target duration (S106).

### <As to Object Relationship Information 20>

As mentioned above, the object relationship information 20 represents two or more action-related relationships between objects. The object relationship information 20 may be generated by the relationship extracting apparatus 2000 or another apparatus. Hereinafter, an apparatus that generates the object relationship information 20 is called “object relationship information generating apparatus”.

The object relationship information generating apparatus generates the object relationship information 20 based on one or more sequences of video frames (in other words, one or more video data) each of which generated by a camera. Specifically, the object relationship information generating apparatus analyzes scenes captured on the video frames and detects action-related relationships between objects captured on the video frames, thereby generating the object relationship information 20.

There may be various ways to acquire the video data. For example, the camera is configured to send the video data to the object relationship information generating apparatus. In this case, the object relationship information generating apparatus receives the video data sent by the camera to acquire the video data.

In another example, the camera is configured to, when it generates a video frame, send this video frame to the object relationship information generating apparatus. In this case, the object relationship information generating apparatus receives the video frames sent by the camera to generate the video data from the received video frames.

In another example, the camera is configured to put the video data into a storage unit to which the object relationship information generating apparatus has access. In this case, the object relationship information generating apparatus acquires the video data from this storage unit.

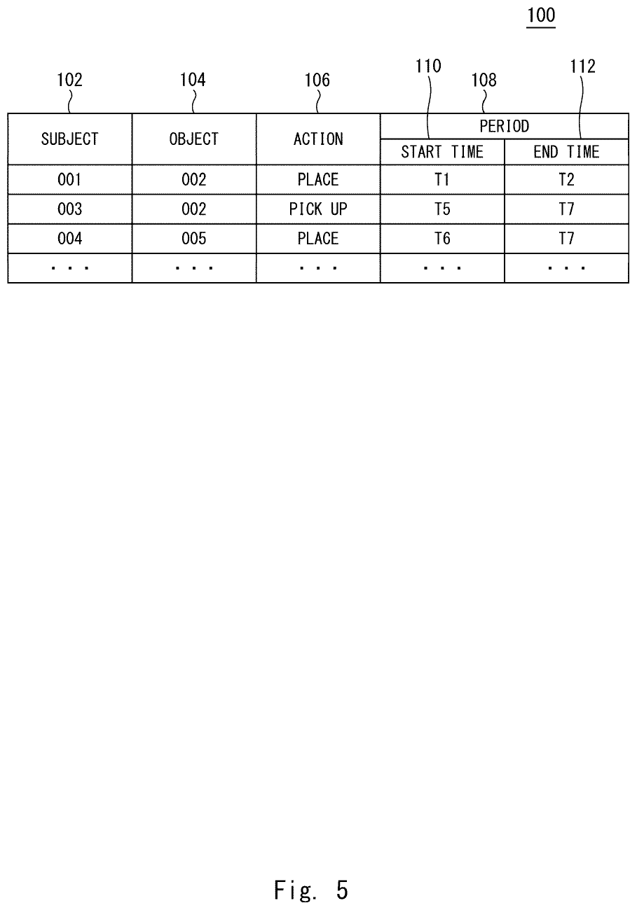

FIG. 5 illustrates an example structure of the object relationship information 20 in a table format. In FIG. 5, the object relationship information 20 is represented by a table 100. The table 100 has columns named “subject 102”, object 104”, “action 106”, and “period 108”. The action 106 indicates a type of action. The subject 102 indicates an identifier of an object that takes the corresponding action. The object 104 indicates an identifier of an object toward which the corresponding subject takes the corresponding action. The period 108 indicates from when to when the corresponding action-related relationship exists. Specifically, the period 108 is comprised of the two columns named “start time 110” and “end time 112”. The start time 110 indicates time at which the corresponding action-related relationship starts. The end time 112 indicates time at which the corresponding action-related relationship ends.

The subject 102 and the object 104 are represented by an identifier of the object. The identifier of each object may be defined by another piece of information, called “object information”, which is also generated from the video data by the object relationship information generating apparatus. The object information may indicate, for each one of the objects detected from the video data, an identifier of the object and a type of the object (e.g., person, store item, bag, etc.).

In the video data, the position of each object may be changed. Thus, it is preferable that the object information indicates pair of time and position for each object. In other words, the object information indicates a time series of the positions for each object.

There may be various ways to represent a position of the object. For example, the position of the object may be represented by coordinates on the video frame at which the object is located. When the object relationship information generating apparatus handles two or more video data, the position of the object may be represented by a pair of a camera identifier and the coordinates on the video frame at which the object is located.

In another example, the position of the object may be represented by coordinates on a map of an area that is captured by one or more cameras. The map may be a two-dimensional map or a three-dimensional map.

In this case, the object relationship information generating apparatus converts the coordinates on the video frame at which the object is located into coordinates on the map. By using the map, the positions of objects that are captured by different cameras from each other can be represented by coordinates on a unified coordinate space. In addition, using the map enables the object relationship information generating apparatus to handle the camera capable of changing its field of view (e.g., a pan-tilt-zoom camera).

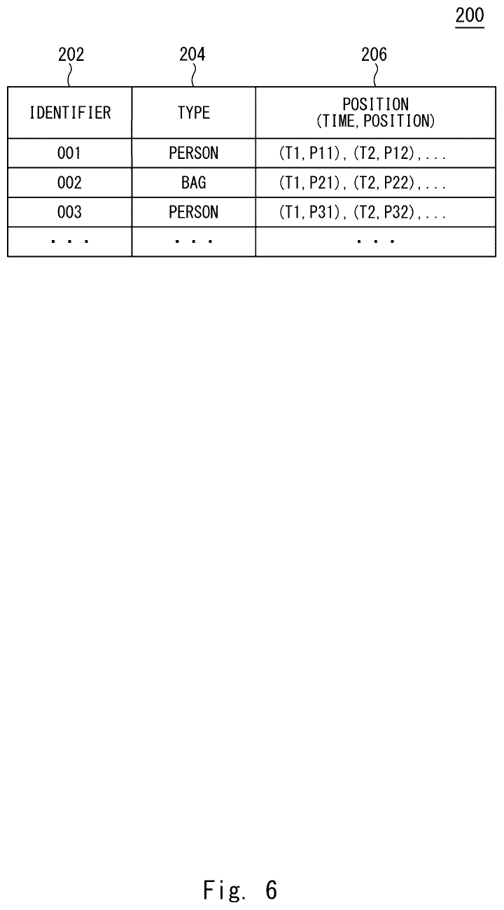

FIG. 6 illustrates an example structure of the object information in a table format. In FIG. 6, the object information is represented by a table 200. The table 200 includes columns named “identifier 202”, “type 204”, and “position 206”. The identifier 202 indicates an identifier that is assigned to the corresponding object. The type 204 indicates a type of the corresponding object. The position 206 indicates a sequence of pairs of the time and the position for the corresponding object.

The action-related relationships between objects at a moment can also be represented by a scene graph, which represents each object by a node and the action-related relationship between objects by an edge. It can be said that the object relationship information 20 represents a sequence of scene graphs. Thus, the relationship extracting apparatus 2000 can be used to search a sequence of scene graphs for action-related relationships that are relevant to the event of interest.

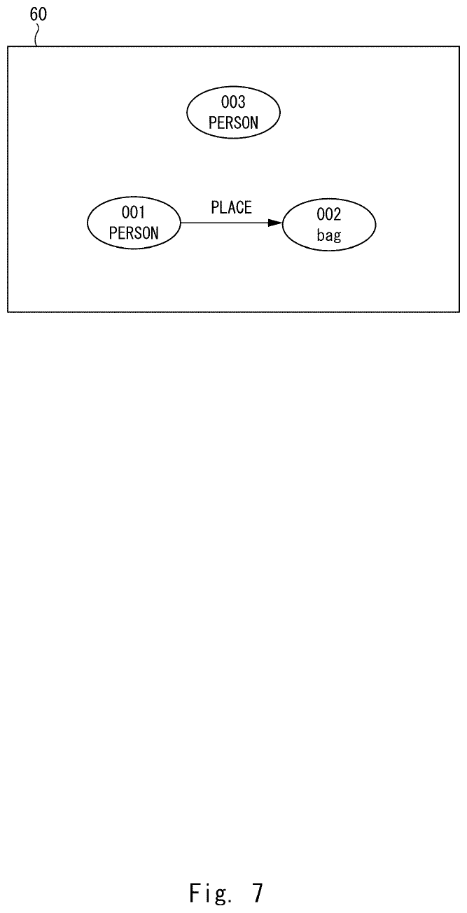

FIG. 7 illustrates an example of the scene graph. In the example shown by FIG. 7, three objects are detected: a person to which an identifier 001 is assigned; a bag to which an identifier 002 is assigned; and another person to which an identifier 003 is assigned. Thus, the scene graph 60 includes three nodes that represent the person 001, the bag 002, and the person 003, respectively.

The person 001 and the bag 002 are connected with each other by an edge that is tagged with “place” and that is directed from the person 001 to the bag 002. This action-related relationship represents that the person 001 places the bag 002. The person 003 is connected with nothing. This means that the person 003 takes no action.

The object relationship information generating apparatus generates the object relationship information 20 from the video data. For example, for each one of the video frames included in the video data, the object relationship information generating apparatus performs object detection to generate the object information and then detects action-related relationships for the objects detected through the object detection.

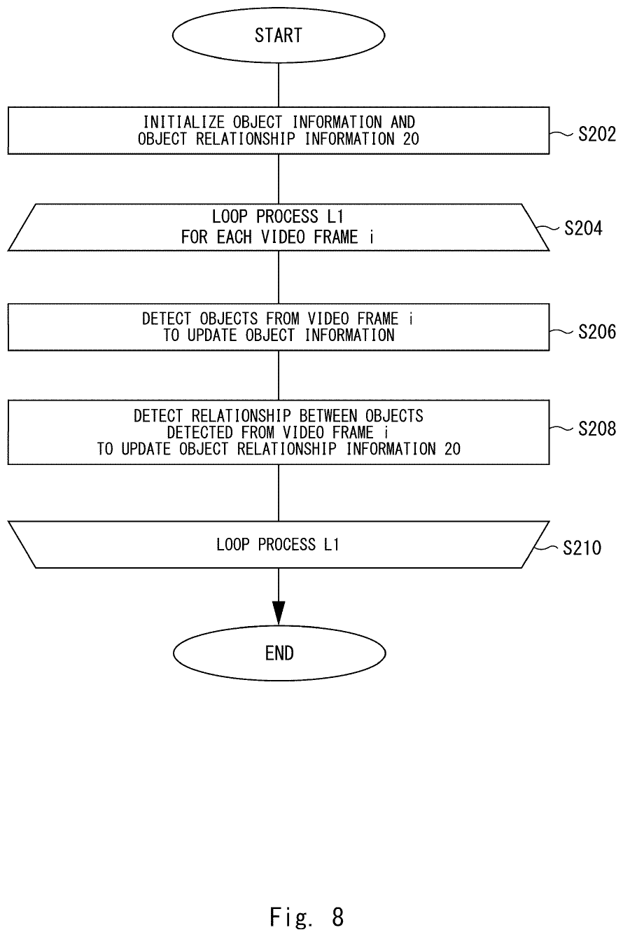

FIG. 8 is a flowchart illustrating a flow of processing performed by the object relationship information generating apparatus. The object relationship information generating apparatus initializes the object information and the object relationship information 20.

Steps S204 to S210 constitute a loop process L1, which is performed for each video frame included in the video data. At Step S204, the object relationship information generating apparatus determines whether or not the loop process L1 has been performed for all the video frames. When the loop process L1 has been performed for all the video frames, the loop process L1 is terminated.

When the loop process L1 has not been performed for all the video frames, the object relationship information generating apparatus selects the video frame for which the loop process L1 is to be performed next. The video frame selected here is the video frame with the earliest time of generation (e.g., with the smallest frame number) of the video frames for which the loop process L1 is not performed yet. The video frame selected here is denoted by “video frame i”.

The object relationship information generating apparatus performs object detection on the video frame i to detect objects from the video frame i, and update the object information (S206). When an object detected from the video frame i has not been detected from the preceding video frames, the object relationship information generating apparatus assigns a new identifier to this object and adds a new record with respect to this object into the object information. When an object detected from the video frame i has been detected from the preceding video frames, the object relationship information generating apparatus updates the record of this object in the object information by adding a pair of time and position of this object to the record. The time of this pair represents the time when the video frame i is generated. The position of this pair represents the position of the object on the video frame i.

The object relationship information generating apparatus performs detection of action-related relationships between objects detected from the video frame i to update the object relationship information 20 (S208). When an action-related relationship between particular objects that is detected from the video frame i is also detected from the video frame (i−1), the object relationship information generating apparatus updates the record of this action-related relationship in the object relationship information 20 to increase the duration of this relationship. On the other hand, when an action-related relationship between particular objects that is detected from the video framed i is not detected from the video frame (i−1), the object relationship information generating apparatus generates a new record with respect to this relationship and adds this record to the object relationship information 20.

Step 210 is the end of the loop process L1. Thus, the object relationship information generating apparatus performs Step S204 next.

### <As to Event Information 10>

The event information 10 indicates information by which features of the event of interest can be identified. As mentioned above, the features of the event of interest include the type of the event of the interest and the event time, which is the time when the event of interest occurs. Thus, the event information 10 indicates the type of the event of the interest and the event time.

In addition, the event information 10 may indicate objects relevant to the event of interest. The objects relevant to the event of interest include the subject of the action involved in the event of interest and the object of the action involved in the event of interest. Suppose that the event of interest is a purchasing of “Object 001 (Person) purchases Object 002 (Store Item) at time t1”. In this case, the objects relevant to the event of interest are Object 001 and Object 002. The event information 10 may indicate: 1) type of event=Purchasing; 2) event time=t1; 3) Purchaser=Object 001; and 4) Purchased Item=Object 002.

In some embodiments, the event of interest is represented by a sequence of action-related situations, each of which is a situation in which a specific subject takes a specific action toward a specific object. In this case, the event information 10 may indicate the subjects of the actions involved in the event of interest and the objects of the actions involved in the event of interest as the objects relevant to the event of interest.

For example, when the event of interest is a purchasing, this event may be represented as follows:

1. Object 001 (Person) picks up Object 002 (Store Item) at time t1.

2. Object 001 (Person) stands in front of Object 003 (Cashier) from time t2 to t3.

3. Object 001 (Person) goes through Object 004 (Exit of Store) at time t4.

In this case, the objects of interest may include Object 001, Object 002, Object 003, and Object 004. The event information 10 may indicate: 1) type of event=Purchasing; 2) event time=t1 to t4; 3) Purchaser=Object 001; 4) Purchased Item=Object 002; 5) Cashier=Object 003; and 6) Exit=Object 004.

It is noted that the event information 10 does not necessarily indicate all the objects relevant to the event of interest. Specifically, the event information 10 may indicate only specific types of objects relevant to the event of interest. For example, regarding Purchasing mentioned above, the event information 10 may indicate only a purchaser and one or more purchased items, and may not indicate a cashier or an exit. Types of objects that are to be indicated by the event information 10 may be pre-defined for each type of event.

### <Acquisition of Event Information 10: S102>

The determining unit 2020 acquires the event information 10 (S102). There may be various ways for the determining unit 2020 to acquire the event information 10. For example, the event information 10 is stored in advance in a storage unit to which the relationship extracting apparatus 2000 has access. In this case, the determining unit 2020 reads the event information 10 out of this storage unit to acquire the event information 10. In another example, another apparatus sends the event information 10 to the relationship extracting apparatus 2000. In this case, the determining unit 2020 receives the event information 10 to acquire the event information 10.

There may be various triggers for the determining unit 2020 to acquire the event information 10 (in other words, to start executing the processing illustrated by FIG. 4). For example, the relationship extracting apparatus 2000 receives a request for providing information regarding the action-related relationships relevant to the event of interest, and acquires the event information 10 in response to the request. In this case, the request includes information by which the event information 10 to be acquired can be identified.

For example, the request includes the event information 10. In this case, the determining unit 2020 acquires the event information 10 by extracting it from the request.

In another example, the request specifies an identifier of the event information 10 to be acquired. Suppose that the event information 10 is stored in a storage unit as a file. In this case, the request specifies the file name of the event information 10 to be acquired. The determining unit 2020 acquires the file with the specified name from the storage unit as the event information 10.

There may be various ways to provide the request to the relationship extracting apparatus 2000. For example, a user of the relationship extracting apparatus 2000 operates an input device attached to the relationship extracting apparatus 2000 to input the request. In another example, the user operates another apparatus, such as a client terminal, to send the request from that apparatus to the relationship extracting apparatus 2000.

The request is not necessarily generated based on the user input. In some embodiments, there is an apparatus, called “event detecting apparatus”, that is configured to detect a specific event from the video data. In this case, the event detected by the event detecting apparatus is handled as the event of interest. The event detecting apparatus generates a request for providing information regarding the action-related relationships relevant to the event detected by the event detecting apparatus, and sends the request to the relationship extracting apparatus 2000.

### <Determination of Target Duration: S104>

The determining unit 2020 determines the target duration based on the event information 10 (S104). In some embodiments, a length of duration may be predefined for each type of the event. This enables the relationship extracting apparatus 2000 to take the type of the event of interest into consideration to determine what information the relationship extracting apparatus 2000 provides.

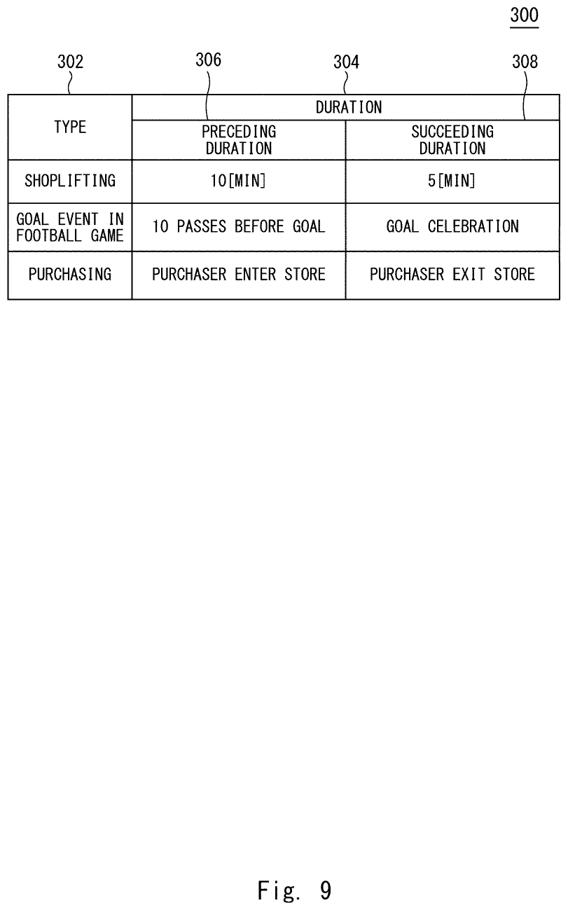

In this case, there is information, called “duration information”, that associates each type of the event with data representing a length of duration. FIG. 9 illustrates an example structure of the duration information in a table format. In FIG. 9, the duration information is represented by a table 300. The table 300 includes columns of “type 302” and “duration 304”. The type 302 indicates the type of the event. The duration 304 indicates data representing a length of the duration corresponding to the type of event.

The duration 304 includes two columns of “preceding duration 306” and “succeeding duration 308”. The preceding duration 306 indicates data representing a length of duration that is included in the target duration and that precedes the event time. The succeeding duration 308 indicates a length of duration that is included in the target duration and that succeeds the event time.

The preceding duration 306, the succeeding duration 308, or both may indicate a length of duration by typical units of time, such as seconds, minutes, or hours. For example, the first row of the table 300 shown by FIG. 9 indicates “Preceding duration: 10 minutes” and “Succeeding duration: 5 minutes”.

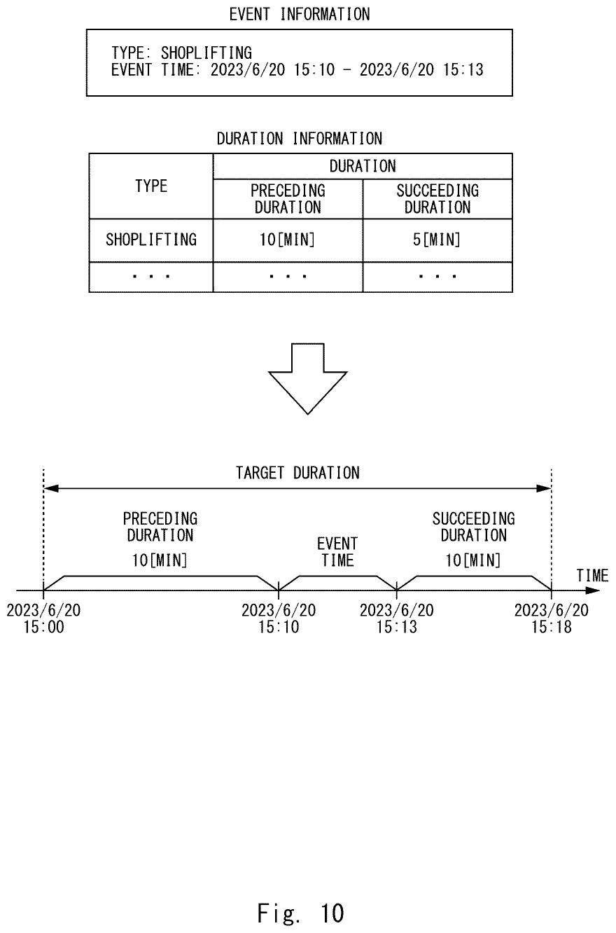

FIG. 10 illustrates the target duration that is determined based on the lengths of time predefined in association with the type of event. The event information 10 indicates that 1) the type of the event of interest is Shoplifting and 2) the event time is from “2023 Jun. 20 15:20” to “2023 Jun. 20 15:13”. The duration information associates “Type: shoplifting” with “Preceding duration: 10 minutes” and “Succeeding duration: 5 minutes”.

Since the start time of the event of interest is “2023 Jun. 20 15:10” and the length of the preceding duration is 10 minutes, the start time of the target duration is determined to be “2023 Jun. 20 15:10”. In addition, since the end time of the event of interest is “2023 Jun. 20 15:13” and the length of the succeeding duration is 5 minutes, the end time of the target duration is determined to be “2023 Jun. 20 15:18”. As a result, the determining unit 2020 determines the target duration as being from “2023 Jun. 20 15:10” to “2023 Jun. 20 15:18”.

In another example, the preceding duration 306 may represent a length of duration using a condition by which the action-related relationship representing the start of the target duration can be determined. Similarly, the succeeding duration 308 may represent a length of duration using a condition by which the action-related relationship representing the end of the target duration can be determined.

Suppose that the type of the event of interest is “Goal Event in Football Game”. In this case, when a goal is scored, a user of the relationship extracting apparatus 2000 (e.g., a viewer of the video of the football game) may be interested in some play before the goal. Thus, the preceding duration 306 may indicate one or more plays to be included in the target duration. For example, the second row of the table 300 shown by FIG. 9 indicates “Preceding duration: 10 passes before goal”. In this case, the determining unit 2020 can determine that the action-related relationship representing the 10th to the last pass before the goal is the action-related relationship representing the start of the target duration.

The second row of the table 300 shown by FIG. 9 indicates “Succeeding duration: goal celebration”. By this definition, the goal celebration is to be included in the target duration. The determining unit 2020 can determine that the action-related relationship representing the end of the goal celebration is the action-related relationship representing the end of the target duration.

The preceding duration 306 may directly indicate a specific action-related relationship that is to be occurred at the start of the target duration. Similarly, the succeeding duration 308 may directly indicate a specific action-related relationship that is to be occurred at the end of the target duration.

For example, the third row of the table 300 shown by FIG. 9 indicates “Preceding duration: Purchaser enters the store” and “Succeeding duration: Purchaser exits the store” in association with “Type: Purchasing”. In this case, the determining unit 2020 can determine the action-related relationship that represents the purchaser entering the store as the action-related relationship that represents the start of the target duration. Similarly, the determining unit 2020 can determine the action-related relationship that represents the purchaser exiting the store as the action-related relationship that represents the end of the target duration.

### <<Adjustment of Duration>>

In some embodiments, the length of the target duration may be adjusted. For example, the relationship extracting apparatus 2000 adjusts the length of the target duration based on a user input. This enables the relationship extracting apparatus 2000 to take user's preference into consideration to determine the target duration.

For example, the user of relationship extracting apparatus 2000 may specify an ambiguity parameter, which is a parameter representing how ambiguous the event of interest is for the user. Conceptually, the more ambiguous the event of interest is for the user, the longer the target duration should be set since the user needs more information to understand the event of interest. Suppose that the event of interest is a shoplifting and that the user of the relationship extracting apparatus 2000 is a store clerk of the store at which the shoplifting occurs. If the store clerk is familiar with the shoplifter (e.g., this shoplifter often comes to the store), the event of interest may be less ambiguous for the store clerk. Thus, the store clerk specifies the ambiguous parameter of a lower value.

On the other hand, if the store clerk is not familiar with the shoplifter (e.g., this is the first time for this shoplifter to come to this store), the event of interest may be ambiguous for the store clerk. Thus, the store clerk specifies the ambiguous parameter of a higher value.

In another example, suppose that the event of interest is a goal event in a football game and that the user of relationship extracting apparatus 2000 is a viewer of this game. If the user is enthusiastically watching the game, the goal event is not ambiguous for the user. Thus, the user specifies the ambiguity parameter of a lower value. On the other hand, if the user is talking with friends while watching the game, the goal event could be ambiguous for the user: e.g., the goal is scored when the user is not looking at the game but the friends. In this case, the user specifies the ambiguity parameter of a higher value.

The determining unit 2020 may adjust the length of the preceding duration, the length of the succeeding duration, or both based on the ambiguity parameter. When adjusting the length of the preceding duration, the determining unit 2020 may determine an adjustment factor based on the ambiguity parameter, and multiply the adjustment parameter and the length of time represented by the preceding duration 306. The determining unit 2020 uses the adjusted length of the preceding duration as the length of the duration from the start time of the target duration to the event time. The adjustment factor is a positive real value within a predefined range.

Similarly, when adjusting the length of the succeeding duration, the determining unit 2020 multiply the adjustment factor and the length of time represented by the preceding duration 306. Then, the determining unit 2020 uses the adjusted length of the succeeding duration as the length of the duration from the event time to the end of the target duration.

The adjustment factor may be the ambiguity parameter as it is or a value obtained by converting the ambiguity parameter using a predefined function. In the latter case, the determining unit 2020 inputs the ambiguity parameter to the predefined function, thereby obtaining the adjustment factor.

Suppose that: the preceding duration 306 indicates 10 minutes; the predefined range of the ambiguity parameter is from 0.5 to 1.5; and the ambiguity parameter is used as the adjustment factor as it is. The user who wants to extend the preceding duration specifies the ambiguity parameter larger than 1. For example, the user can extend the preceding duration to 15 minutes by specifying the ambiguity parameter of 1.5.

On the other hand, the user who wants to shorten the preceding duration specifies the ambiguity parameter less than 1. For example, the user can shorten the preceding duration to 5 minutes by specifying the ambiguity parameter of 0.5.

It is noted that the adjustment factor for adjusting the length of the preceding duration and the adjustment factor for adjusting the length of the succeeding duration may be the same as each other or different from each other. In the latter case, for example, the function to convert the ambiguity parameter into the adjustment factor used for the preceding duration and the function to convert the ambiguity parameter into the adjustment factor used for the succeeding duration are separately predefined.

It is not necessarily the ambiguity parameter to adjust the length of the target duration. For example, the determining unit 2020 allows the user to specify an importance parameter, which representing how important the event of interest is for the user. In this case, the adjustment factor is set to be larger as the importance factor is larger.

In another example, the determining unit 2020 allows the user to specify a curiosity parameter, which representing how curious the user is about the event of interest. In this case, the adjustment factor is set to be larger as the curiosity parameter is larger.

In some embodiments, the relationship extracting apparatus 2000 adjusts the length of the target duration based on temporal concentration of the action-related relationships that include objects related to the event of interest. Hereinafter, objects related to the event of interest are called “objects of interest”.

When duration around the event of interest that includes the action-related relationships involving objects of interest is longer (i.e., the temporal concentration of the action-related relationships involving objects of interest is lower), the target duration should be longer since the information that the user of the relationship extracting apparatus 2000 requires may widely spread in time. On the other hand, when duration around the event of interest that includes the action-related relationships involving objects of interest is shorter (i.e., the temporal concentration of the action-related relationships involving objects of interest is higher), the target duration can be shorter since the information that the user of the relationship extracting apparatus 2000 requires may concentrate in time.

Specifically, the determining unit 2020 determines the adjustment factor based on the temporal concentration of the action-related relationships involving the object of interest. For example, the determining unit 2020 determines a length of the duration that includes the event of interest and that includes at least one of the objects of interest. Then, the determining unit 2020 computes a ratio of the computed length of this duration to a predefined standard length, and determine the adjustment factor based on this ratio. For example, this ratio may be used as the adjustment factor as it is. In another example, a specific function is used to covert this ratio into the adjustment factor.

It is noted that the object of interest is one or more objects relevant to the event of interest. The more detailed explanation about the object of interest will be described later.

### <Extraction of Relationships: S106>

The extracting unit 2040 extracts the action-related relationships that are relevant to the event of interest based the target duration (S106). Specifically, the extracting unit 2040 extracts the action-related relationships that satisfy a condition that “the action-related relationship exists during the target duration”. Hereinafter, this condition is called “first condition”.

To extract the action-related relationships that are relevant to the event of interest, the extracting unit 2040 searches the object relationship information 20 for the action-related relationships that satisfy the first condition. When the start and the end of the target duration are represented by date and time, the extracting unit 2040 determines whether or not the action-related relationship exists during the target duration by comparing the period 108 with the target duration. Specifically, the action-related relationship whose period 108 overlaps the target duration is determined to satisfy the first condition. On the other hand, the action-related relationship whose period 108 does not overlap the target duration is determined not to satisfy the first condition.

As mentioned above, there is a case where the start and the end of the target duration are represented by specific action-related relationships. For example, the start of the target duration may be represented by the action-related relationship that represents the 10th to the last pass before the goal. In this case, as the action-related relationships that satisfy the first condition, the extracting unit 2040 determines all the action-related relationships that the object relationship information 20 includes between the action-related relationship representing the start of the target duration and the action-related relationship representing the end of the target duration.

Suppose that the i-th action-related relationship included in the object relationship information 20 represents the start of the target duration, while the j-th action-related relationship included in the object relationship information 20 represents the end of the target duration. In this case, all the action-related relationships between the i-th one and the j-th one in the object relationship information 20 are determined to satisfy the first condition.

In some embodiments, an additional condition is employed to determine whether or not the action-related relationship is relevant to the event of interest. An example of the additional condition is that the action-related relationship involves an object of interest. More specifically, the condition of “the subject, the object, or both of the action-related relationship is the object of interest” can be employed as the additional condition. Hereinafter, this condition is called “second condition”.

The object of interest is one or more objects relevant to the event of interest. In some embodiments, all the subjects and the objects of the actions included in the event of interest are handled as the objects of interest. In other embodiments, some of all the subjects and the objects of the actions included in the event of interest are handled as the objects of interest.

In the latter case, the extracting unit 2040 may handle one or more specific types of objects as the objects of interest. Suppose that a user of the relationship extracting apparatus 2000 is interested in behaviors of human relevant to the event of interest. In this case, it is preferable to handle, as the object of interest, each person who is the subject or the object of an action included in the event of the interest.

Alternatively, the extracting unit 2040 may handle one or more specific objects as the objects of interest. Suppose that the event of interest is a criminal event, such as Shoplifting. In this case, the user of the relationship extracting apparatus 2000 may be interested in behaviors of the criminal (e.g., shoplifter) of the event of interest. Thus, it may be preferable to handle the criminal of the event of interest as the object of interest.

When the second condition is also employed, the extracting unit 2040 extracts, as the action-related relationship relevant to the event of interest, the action-related relationships that satisfy both the first and the second conditions. For example, the extracting unit 2040 extracts the action-related relationships that satisfy the first condition (i.e., that exist during the target duration) from the object relationship information 20. Then, from those extracted action-related relationships, the extracting unit 2040 extracts the action-related relationships that satisfy the second condition (i.e., that involve the object of interest).

The extracting unit 2040 may determine whether or not the action-related relationship satisfies the second condition based on the subject 102 and the object 104 of the action-related relationship. Specifically, the action-related relationship whose subject 102 or object 104 indicates the object of the interest is determined to satisfy the second condition. On the other hand, the action-related relationship neither whose subject 102 nor whose object 104 indicates an object of the interest is determined not to satisfy the second condition.

### <Output of Result>

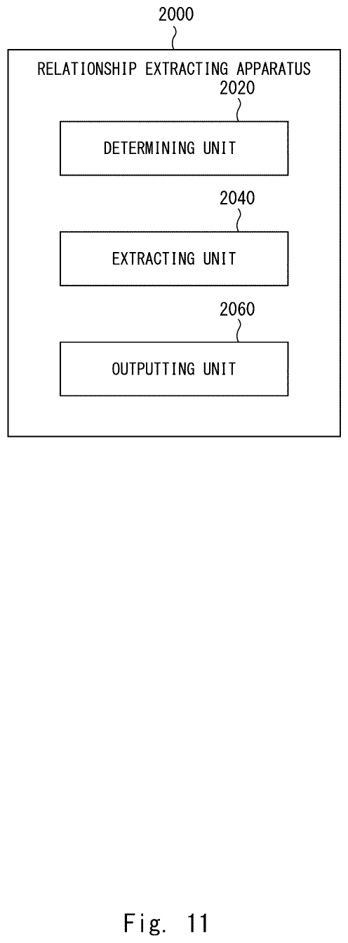

The relationship extracting apparatus 2000 may output information (hereinafter, “output information”) that is related to a result of the extraction of the action-related relationships relevant to the event of interest. A functional unit that generates the output information is called “outputting unit”. FIG. 11 illustrates an example of the functional configuration of the relationship extracting apparatus 2000 that includes the outputting unit 2060.

There may be various information that the output information includes. For example, the outputting unit 2060 generates the output information that includes all the action-related relationships that are extracted by the extracting unit 2040 as being relevant to the event of interest.

In addition to or instead of the action-related relationships relevant to the event of interest, the output information may include one or more of the video frames from which the action-related relationships relevant to the event of interest are detected. By providing those video frames, the user of the relationship extracting apparatus 2000 can visually, and thus easily, understand the scenes relevant to the event of interest. For example, when the event of interest is a shoplifting, the user of the relationship extracting apparatus 2000 can watch the video frames on which behaviors of the shoplifter before, on, and after the shoplifting are captured.

It is noted that the output information may include all the video frames from which the action-related relationships relevant to the event of interest are detected or may include some of them. In the latter case, the output information may include a specific number (e.g., one) of the video frames for each one of the action-related relationships relevant to the event of interest.

Suppose that there is an action-related relationship representing that a shoplifter picks up a store item. If this relationship exists for two seconds, there are tens of video frames (e.g., 60 video frames when the frame rate of the camera is 30 frames/sec) from which this relationship is detected. In this case, it may be sufficient for the user to see one or a few of the video frames to understand the behavior of the shoplifter picking up the store item. Thus, the outputting unit 2060 includes a specific number of the video frames as representative ones for each action-related relationship relevant to the event of interest.

There may be various ways to output the output information. For example, the relationship extracting apparatus 2000 may put the output information into a storage unit. In another example, the relationship extracting apparatus 2000 may output the output information to a display device, thereby causing the display device to display the contents of the output information. In another example, the relationship extracting apparatus 2000 may send the output information to another apparatus: e.g., a client terminal from which the above-mentioned request is sent to the relationship extracting apparatus 2000.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

An example advantage according to the above-described embodiments is that a novel technique to provide information relevant to an event of interest is provided.

The whole or part of the example embodiments disclosed above can be described as, but not limited to, the following supplementary notes.

### <Supplementary Notes>

### (Supplementary Note 1)

A relationship extracting apparatus comprising:
at least one memory that is configured to store instructions; and
at least one processor that is configured to execute the instructions to:
acquire event information that indicates one or more features of an event of interest;
determine target duration based on the one or more features of the event of interest, the target duration including, as a part thereof, an event time at which or during which the event of interest occurs; and
extract one or more action-related relationships that exist during the target duration from object relationships information, which indicates two or more action-related relationships between objects in association with time at which or during which the action-related relationship exists.

### (Supplementary Note 2)

The relationship extracting apparatus according to Supplementary note 1,
wherein the one or more features of the event of interest include a type of the event of interest and the event time, and
wherein the determination of the target duration includes:
determining a start time of the target duration by determining a length of time from the start time of the target duration to the event time based on the type of the event of interest; and
determining an end time of the target duration by determining a length of time from the event time to the end time of the target duration based on the type of the event of interest.

### (Supplementary Note 3)

The relationship extracting apparatus according to Supplementary note 2,
wherein the determination of the target duration includes:
acquiring duration information that indicates, for each one of two or more types of event, associations between the type of the event and a length of duration; and
determining the start time of the target duration and the end time of the target duration based on the length of duration indicated by the duration information in association with the type of the event of interest.

### (Supplementary Note 4)

The relationship extracting apparatus according to Supplementary note 3,
wherein the determination of the target duration includes:
acquiring an adjustment factor that is a positive real value; and
adjusting the length of time from the start of the target period to the event time, the length of time from the event time to the end of the target period, or both based on the adjustment factor.

### (Supplementary Note 5)

The relationship extracting apparatus according to Supplementary note 4,
wherein the adjustment factor is determined by a parameter representing how ambiguous the event of interest is for a user, how important the event of interest is for a user, or how curious the user is about the event of interest.

### (Supplementary Note 6)

The relationship extracting apparatus according to any one of Supplementary notes 1 to 5,
wherein the extraction of the action-related relationships includes extracting, from the object relationship information, one or more action-related relationships that exist during the target duration and that involve an object relevant to the event of interest.

### (Supplementary Note 7)

The relationship extracting apparatus according to any one of Supplementary notes 1 to 6,
wherein the object relationship information is generated by detecting each one of the action-related relationships from one or more video frames, and
wherein the at least one processor is configured to execute the instructions further to:
output output information that includes, for each one of the extracted action-related relationships, one or more video frames from which the extracted action-related relationship is detected.

### (Supplementary Note 8)

The relationship extracting apparatus according to Supplementary note 7,
wherein the output information includes, for each one of the extracted action-related relationships, a specific number of one or more video frames from which the extracted action-related relationship is detected.

### (Supplementary Note 9)

A relationship extracting method comprising:
acquiring event information that indicates one or more features of an event of interest;
determining target duration based on the one or more features of the event of interest, the target duration including, as a part thereof, an event time at which or during which the event of interest occurs; and
extracting one or more action-related relationships that exist during the target duration from object relationships information, which indicates two or more action-related relationships between objects in association with time at which or during which the action-related relationship exists.

### (Supplementary Note 10)

The relationship extracting method according to Supplementary note 9,
wherein the one or more features of the event of interest include a type of the event of interest and the event time, and
wherein the determination of the target duration includes:
determining a start time of the target duration by determining a length of time from the start time of the target duration to the event time based on the type of the event of interest; and
determining an end time of the target duration by determining a length of time from the event time to the end time of the target duration based on the type of the event of interest.

### (Supplementary Note 11)

The relationship extracting method according to Supplementary note 10,
wherein the determination of the target duration includes:
acquiring duration information that indicates, for each one of two or more types of event, associations between the type of the event and a length of duration; and
determining the start time of the target duration and the end time of the target duration based on the length of duration indicated by the duration information in association with the type of the event of interest.

### (Supplementary Note 12)

The relationship extracting method according to Supplementary note 11,
wherein the determination of the target duration includes:
acquiring an adjustment factor that is a positive real value; and
adjusting the length of time from the start of the target period to the event time, the length of time from the event time to the end of the target period, or both based on the adjustment factor.

### (Supplementary Note 13)

The relationship extracting method according to Supplementary note 12,
wherein the adjustment factor is determined by a parameter representing how ambiguous the event of interest is for a user, how important the event of interest is for a user, or how curious the user is about the event of interest.

### (Supplementary Note 14)

The relationship extracting method according to any one of Supplementary notes 9 to 13,
wherein the extraction of the action-related relationships includes extracting, from the object relationship information, one or more action-related relationships that exist during the target duration and that involve an object relevant to the event of interest.

### (Supplementary Note 15)

The relationship extracting method according to any one of Supplementary notes 9 to 14,
wherein the object relationship information is generated by detecting each one of the action-related relationships from one or more video frames, and
wherein the relationship extracting method further comprises:
output output information that includes, for each one of the extracted action-related relationships, one or more video frames from which the extracted action-related relationship is detected.

### (Supplementary Note 16)

The relationship extracting method according to Supplementary note 15,
wherein the output information includes, for each one of the extracted action-related relationships, a specific number of one or more video frames from which the extracted action-related relationship is detected.

### (Supplementary Note 17)

A non-transitory computer-readable storage medium storing a program that causes a computer to execute:
acquiring event information that indicates one or more features of an event of interest;
determining target duration based on the one or more features of the event of interest, the target duration including, as a part thereof, an event time at which or during which the event of interest occurs; and
extracting one or more action-related relationships that exist during the target duration from object relationships information, which indicates two or more action-related relationships between objects in association with time at which or during which the action-related relationship exists.

### (Supplementary Note 18)

The storage medium according to Supplementary note 17,
wherein the one or more features of the event of interest include a type of the event of interest and the event time, and
wherein the determination of the target duration includes:
determining a start time of the target duration by determining a length of time from the start time of the target duration to the event time based on the type of the event of interest; and
determining an end time of the target duration by determining a length of time from the event time to the end time of the target duration based on the type of the event of interest.

### (Supplementary Note 19)

The storage medium according to Supplementary note 18,
wherein the determination of the target duration includes:
acquiring duration information that indicates, for each one of two or more types of event, associations between the type of the event and a length of duration; and
determining the start time of the target duration and the end time of the target duration based on the length of duration indicated by the duration information in association with the type of the event of interest.

### (Supplementary Note 20)

The storage medium according to Supplementary note 19,
wherein the determination of the target duration includes:
acquiring an adjustment factor that is a positive real value; and
adjusting the length of time from the start of the target period to the event time, the length of time from the event time to the end of the target period, or both based on the adjustment factor.

### (Supplementary Note 21)

The storage medium according to Supplementary note 20,
wherein the adjustment factor is determined by a parameter representing how ambiguous the event of interest is for a user, how important the event of interest is for a user, or how curious the user is about the event of interest.

### (Supplementary Note 22)

The storage medium according to any one of Supplementary notes 17 to 21,
wherein the extraction of the action-related relationships includes extracting, from the object relationship information, one or more action-related relationships that exist during the target duration and that involve an object relevant to the event of interest.

### (Supplementary Note 23)

The storage medium according to any one of Supplementary notes 17 to 22,
wherein the object relationship information is generated by detecting each one of the action-related relationships from one or more video frames, and
wherein the program causes the computer to further execute:
output output information that includes, for each one of the extracted action-related relationships, one or more video frames from which the extracted action-related relationship is detected.

### (Supplementary Note 24)

The storage medium according to Supplementary note 23,
wherein the output information includes, for each one of the extracted action-related relationships, a specific number of one or more video frames from which the extracted action-related relationship is detected.

What is claimed is:

1. A relationship extracting apparatus comprising:
at least one memory that is configured to store instructions; and
at least one processor that is configured to execute the instructions to:
acquire event information that indicates one or more features of an event of interest;
determine target duration based on the one or more features of the event of interest, the target duration including, as a part thereof, an event time at which or during which the event of interest occurs; and
extract one or more action-related relationships that exist during the target duration from object relationships information, which indicates two or more action-related relationships between objects in association with time at which or during which the action-related relationship exists.

2. The relationship extracting apparatus according to claim 1,
wherein the one or more features of the event of interest include a type of the event of interest and the event time, and
wherein the determination of the target duration includes:
determining a start time of the target duration by determining a length of time from the start time of the target duration to the event time based on the type of the event of interest; and
determining an end time of the target duration by determining a length of time from the event time to the end time of the target duration based on the type of the event of interest.

3. The relationship extracting apparatus according to claim 2,
wherein the determination of the target duration includes:
acquiring duration information that indicates, for each one of two or more types of event, associations between the type of the event and a length of duration; and
determining the start time of the target duration and the end time of the target duration based on the length of duration indicated by the duration information in association with the type of the event of interest.

4. The relationship extracting apparatus according to claim 3,
wherein the determination of the target duration includes:
acquiring an adjustment factor that is a positive real value; and
adjusting the length of time from the start of the target period to the event time, the length of time from the event time to the end of the target period, or both based on the adjustment factor.

5. The relationship extracting apparatus according to claim 4,
wherein the adjustment factor is determined by a parameter representing how ambiguous the event of interest is for a user, how important the event of interest is for a user, or how curious the user is about the event of interest.

6. The relationship extracting apparatus according to claim 1,
wherein the extraction of the action-related relationships includes extracting, from the object relationship information, one or more action-related relationships that exist during the target duration and that involve an object relevant to the event of interest.

7. The relationship extracting apparatus according to claim 1,
wherein the object relationship information is generated by detecting each one of the action-related relationships from one or more video frames, and
wherein the at least one processor is configured to execute the instructions further to:
output output information that includes, for each one of the extracted action-related relationships, one or more video frames from which the extracted action-related relationship is detected.

8. The relationship extracting apparatus according to claim 7,
wherein the output information includes, for each one of the extracted action-related relationships, a specific number of one or more video frames from which the extracted action-related relationship is detected.

9. A relationship extracting method comprising:
acquiring event information that indicates one or more features of an event of interest;
determining target duration based on the one or more features of the event of interest, the target duration including, as a part thereof, an event time at which or during which the event of interest occurs; and
extracting one or more action-related relationships that exist during the target duration from object relationships information, which indicates two or more action-related relationships between objects in association with time at which or during which the action-related relationship exists.

10. The relationship extracting method according to claim 9,
wherein the one or more features of the event of interest include a type of the event of interest and the event time, and
wherein the determination of the target duration includes:
determining a start time of the target duration by determining a length of time from the start time of the target duration to the event time based on the type of the event of interest; and
determining an end time of the target duration by determining a length of time from the event time to the end time of the target duration based on the type of the event of interest.

11. The relationship extracting method according to claim 10,
wherein the determination of the target duration includes:
acquiring duration information that indicates, for each one of two or more types of event, associations between the type of the event and a length of duration; and
determining the start time of the target duration and the end time of the target duration based on the length of duration indicated by the duration information in association with the type of the event of interest.

12. The relationship extracting method according to claim 11,
wherein the determination of the target duration includes:
acquiring an adjustment factor that is a positive real value; and
adjusting the length of time from the start of the target period to the event time, the length of time from the event time to the end of the target period, or both based on the adjustment factor.

13. The relationship extracting method according to claim 12,
wherein the adjustment factor is determined by a parameter representing how ambiguous the event of interest is for a user, how important the event of interest is for a user, or how curious the user is about the event of interest.

14. The relationship extracting method according to claim 9,
wherein the extraction of the action-related relationships includes extracting, from the object relationship information, one or more action-related relationships that exist during the target duration and that involve an object relevant to the event of interest.

15. A non-transitory computer-readable storage medium storing a program that causes a computer to execute:
acquiring event information that indicates one or more features of an event of interest;
determining target duration based on the one or more features of the event of interest, the target duration including, as a part thereof, an event time at which or during which the event of interest occurs; and
extracting one or more action-related relationships that exist during the target duration from object relationships information, which indicates two or more action-related relationships between objects in association with time at which or during which the action-related relationship exists.

16. The storage medium according to claim 15,
wherein the one or more features of the event of interest include a type of the event of interest and the event time, and
wherein the determination of the target duration includes:
determining a start time of the target duration by determining a length of time from the start time of the target duration to the event time based on the type of the event of interest; and
determining an end time of the target duration by determining a length of time from the event time to the end time of the target duration based on the type of the event of interest.

17. The storage medium according to claim 16,
wherein the determination of the target duration includes:
acquiring duration information that indicates, for each one of two or more types of event, associations between the type of the event and a length of duration; and
determining the start time of the target duration and the end time of the target duration based on the length of duration indicated by the duration information in association with the type of the event of interest.

18. The storage medium according to claim 17,
wherein the determination of the target duration includes:
acquiring an adjustment factor that is a positive real value; and
adjusting the length of time from the start of the target period to the event time, the length of time from the event time to the end of the target period, or both based on the adjustment factor.

19. The storage medium according to claim 18,
wherein the adjustment factor is determined by a parameter representing how ambiguous the event of interest is for a user, how important the event of interest is for a user, or how curious the user is about the event of interest.

20. The storage medium according to claim 19,
wherein the determination of the target duration includes:
acquiring an adjustment factor that is a positive real value; and
adjusting the length of time from the start of the target period to the event time, the length of time from the event time to the end of the target period, or both based on the adjustment factor.
